(19) United States
(12) Patent Application Publication
(10) Pub. No.: US 2015/0006390 A1
(43) Pub. Date: Jan. 1, 2015

(54) USING STEGANOGRAPHY TO PERFORM PAYMENT TRANSACTIONS THROUGH INSECURE CHANNELS

(71) Applicant: Visa International Service Association, San Francisco, CA (US)

(72) Inventors: Selim Aissi, Menlo Park, CA (US); Taeho Kgil, Foster City, CA (US); Ajit Gaddam, Sunnyvale, CA (US); Robert Rutherford, New York, NY (US)

(21) Appl. No.: 14/312,258

(22) Filed: Jun. 23, 2014

Related U.S. Application Data
(60) Provisional application No. 61/839,762, filed on Jun. 26, 2013.

(51) Int. Cl. G06Q 20/40; H04N 19/80; H04N 19/46

(52) U.S. Cl. CPC G06Q 20/40; H04N 19/00545; H04N 19/0089
USPC 705/44; 375/240.29

(57) ABSTRACT

Steganographic techniques are used to embed financial information or authentication information within an image, audio, or video file using a quantization table and/or other filter. The file is then transmitted over an insecure network, such as a GSM cell phone network, and a server extracts the information from the image, audio, or video using the same quantization table and/or filter. Multiple sets of information, such as telephone numbers and/or payment account numbers, are extracted from the same image by those entities possessing the appropriate keys. The filters and tables used to embed financial information can be updated periodically or according to events. A video of images, some with embedded information, some with ‘dummy’ data, can be used to hide information over insecure networks for payment transactions.

### CROSS-REFERENCES TO RELATED APPLICATIONS

This application claims the benefit of U.S. Provisional Application No. 61/839,762, filed Jun. 26, 2013, which is hereby incorporated by reference in its entirety for all purposes.

### BACKGROUND

1. Field

Generally, the present application relates to data processing. Specifically, the application is related to secure steganographic techniques applied to payment transactions made over insecure channels and networks.

2. Discussion of the Related Art

Early cellular telephone channels were not originally designed to carry data. Furthermore, some cell channels are largely insecure. GSM (Global System for Mobile Communications) is one such example. Some standards, such as USSD (Unstructured Supplementary Service Data) and SMS (Short Message Service) can be used by GSM in order to send data; however, they are not secure. In many developing parts of the world, these cell channels and standards are prevalent, and probably will be for the foreseeable future.

People in developing countries wish to use their cell phones to facilitate transactions. There is a problem in communicating financial information over these insecure channels without compromising a person's financial information. There is little other infrastructure to support consumers using their cell phones to conduct transactions.

In some villages, a central person acts as a banker for the area, giving cash to people in exchange for their sending him money wirelessly. The banker may have a phone in which a ‘customer's’ SIM card is placed, and the customer can use the phone to make a payment. In these situations, there is a possibility that the SIM card is stolen or that the transaction is otherwise not authorized. More problematically, it could be that transmitting financial information previously allowed the data to slip into the hands of an identity thief, and now the thief, unknown to the customer, is trying to craft his or her own transaction. The bank or other financial institution at the other end of the phone has little to no way of preventing losses from eavesdropped information gleaned from unsecure lines.

The problem of unsecure data channels is not only prevalent in the developing world, but is also prevalent in the developed world. “Man in the middle” attacks also occur in the data channels that are present in the developing world, so there is a need to provide for more secure ways to transmit and receive data.

Yet another problem that exists is respect to authentication. Current transaction processes include authentication techniques that require additional steps including the transmission and receipt of security tokens such as passwords. It would be desirable to reduce the number of steps in transactions to improve the efficiency of such transactions.

Embodiments of the invention address these and other problems, individually and collectively.

### BRIEF SUMMARY

This present disclosure is generally related to methods of securing payment transactions made over insecure channels and networks, by applying steganographic techniques to hide payment credentials within files, which are then transmitted and decoded by the recipients. The steganographic techniques are applied to embed payment credentials, for example a CVV (card verification value), expiration date, or account number, in sound, image or video files using compression filters which may include quantization tables, for example those compatible with the JPEG (Joint Photographic Experts Group) or MPEG (Moving Picture Experts Group) standards.

Multiple items, such as a payment credential and a SIM (subscriber identity module) number, can be hidden by steganographic techniques in a single multimedia file using different keys or encryption techniques. A first recipient with a first key can extract the first item, and a second recipient with a second key can extract the second item, while neither recipient can extract the other item. For example, a payment network extracts an account number while a telephony network extracts the phone number on the sender's SIM card.

Multiple compression filters, including multiple images, and embedded multiple payment credentials may be used. Compression filters and quantization tables can be updated dynamically. Payment credentials can be sent embedded within an image that is part of a video. These video payment messages can be posted to social media sites and tagging intended recipients and trusted payment networks. Payment transactions can be initiated following the extraction of embedded payment credentials.

Some embodiments are related to methods of representing payment account credentials via embedding media with steganographic signatures.

Some embodiments are related to methods of sending payment information through a video.

Some embodiments of the present invention are related to a method. The method includes providing a first compression filter, providing a sound, image, or video, providing a payment account credential, embedding the payment account credential in the sound, image, or video using the first compression filter, transmitting the sound, image, or video over an insecure channel, determining that an event has occurred related to the insecure channel, obtaining a second compression filter based on the determination of the event occurring, embedding the payment account credential in the sound, image, or video using the second compression filter, and transmitting the sound, image, or video over the insecure channel.

The method can include where the first and second compression filters include a quantization table. The method can include wherein the quantization table is rotated prior to using the first and second compression filters. The method can include wherein the quantization table is compatible with a standard of a Join Photographic Experts Group (JPEG) or Moving Picture Experts Group (MPEG). The embedding can use a lossy codec. The embedding may not be specific to a location on the sound, image, or video. The method can include wherein the first payment account credential is selected from the group consisting of an account number, an expiration date, and a card verification value. The method can include wherein the second payment account credential includes a subscriber identity module (SIM) card number. The method can include wherein the sound, image, or video is received from a trusted payment network.

Some embodiments of the present invention are related to a method. The method includes receiving a first payment account credential, receiving a second payment account credential, receiving a sound, image, or video, selecting a first compression filter, selecting a second compression filter, embedding the first payment account credential in the sound, image, or video, using the first compression filter, and embedding the second payment account credential in the sound, image, or video, using the second compression filter to create a second sound, image, or video, transmitting the second sound, image, or video over an insecure channel to a trusted payment network, transmitting the second sound, image, or video over an insecure channel to a telephony service provider, extracting the first payment account credential from the second sound, second image, or second video using a copy of the first compression filter at the trusted payment network, sending an authorization request message through the trusted payment network based on the first payment account credential, thereby initiating a payment transaction, receiving an authorization response message from the trusted payment network, extracting the second payment account credential from the second sound, second image, or second video using a copy of the second compression filter at the telephony service provider, sending an authorization request message through the telephony service provider based on the second payment account credential, thereby initiating a payment transaction, and receiving an authorization response message from the telephony service provider.

The compression filter can include a quantization table. The quantization table can be rotated prior to using the compression filter. The quantization table can be compatible with a standard of a Join Photographic Experts Group (JPEG) or Moving Picture Experts Group (MPEG). The first payment account credential can be selected from the group consisting of an account number, an expiration date, and a card verification value.

Some embodiments of the present invention are related to a method. The method includes encoding a machine-readable image code with payment information in a first image, providing a set of other images, the set of other images including a trigger image, randomly selecting an order of the first image within the set of other images, and sending to a trusted payment network the images in the selected order to form a video payment message, the trigger image signaling the position of the first image.

The method can include sending the video payment message to a social networking platform and tagging, on the social networking platform, an intended recipient of the payment information to the video payment message. The method can include tagging, on the social networking platform a trusted payment network to the video payment message. The payment information encoded in the image code can be for a recipient's account, and sending the video payment message can be made to a social networking platform. Tagging, on the social networking platform, a trusted payment network to the video payment message can also be implemented. The method can include sending the video payment message to a social networking platform, tagging, on the social networking platform, an intended recipient of the payment information to the video payment message, and forwarding or submitting by the intended recipient, the video payment message to a trusted payment network. The method can include sending an authorization request message through the trusted payment network based on the payment information in the video payment message, thereby initiating a payment transaction, and receiving an authorization response message from the trusted payment network.

Some embodiments of the present invention are related to a method that includes receiving a payment account credential, receiving a sound, image, or video, selecting a compression filter, embedding the payment account credential in the sound, image, or video using the compression filter to create a second sound, second image, or second video, transmitting the second sound, second image, or second video over an insecure channel to a trusted payment network, extracting the payment account credential from the second sound, second image, or second video using a copy of the compression filter at the trusted payment network, sending an authorization request message through the trusted payment network based on the payment account credential, thereby initiating a payment transaction, and receiving an authorization response message from the trusted payment network in response to the authorization request message.

The embedding can use a lossy codec. The embedding may be non-location-based. The method can include wherein the first payment account credential is selected from the group consisting of an account number, an expiration date, and a card verification value. The second payment account credential may include a subscriber identity module (SIM) card number. The sound, image, or video can be received from a trusted payment network. The compression filter can include a quantization table. The quantization table can be rotated prior to using the compression filter. The quantization table can be compatible with a standard of a Join Photographic Experts Group (JPEG) or Moving Picture Experts Group (MPEG).

### BRIEF DESCRIPTION OF THE DRAWINGS

FIG. 1 illustrates embedding multiple payment credentials into a sound, image, or video using multiple compression filters, transmitting the sound, image, or video over an insecure channel, extracting credentials, authenticating, and initiating a transaction in accordance with an embodiment.

FIG. 2 illustrates updating the compression codes for embedding steganographic signatures upon an event occurring and retransmitting an embedded sound, image, or video over an insecure channel in accordance with an embodiment.

FIG. 3 illustrates embedding a payment credential into a sound, image, or video using a compression filter, transmitting the sound, image, or video over an insecure channel, extracting the credential, authenticating, and initiating a transaction in accordance with an embodiment.

FIG. 4 illustrates sending payment information through a video, by inserting an image with payment information embedded, into a set of other images in a random location to form a video payment message and sending that video to a trusted payment network in accordance with an embodiment.

FIG. 5 is an image having information steganographically embedded in several different areas in accordance with an embodiment.

FIG. 6 illustrates steganographically embedding payment card information in audio or an image using a quantization table or filter in accordance with an embodiment.

FIG. 7 illustrates a system that is configured to send a steganographic image or audio over an insecure network in accordance with an embodiment.

FIG. 8 illustrates a mobile phone sending a steganographic image or audio clip through a point of sale terminal to a trusted backend server in accordance with an embodiment.

FIGS. 9A-9B illustrate embedding and extracting an image and data, respectively, in accordance with an embodiment.

FIG. 10 shows an exemplary mobile device in accordance with some embodiments.

FIG. 11 is a flowchart showing a process in accordance with an embodiment.

FIG. 12 is a flowchart showing a process in accordance with an embodiment.

FIG. 13 is a flowchart showing a process in accordance with an embodiment.

FIG. 14 is a flowchart showing a process in accordance with an embodiment.

### DETAILED DESCRIPTION

The following disclosure may provide exemplary systems, devices, and methods for conducting a financial transaction and related activities. Although reference may be made to such financial transactions in the examples provided below, embodiments are not so limited. That is, the systems, methods, and apparatuses described may be utilized for any suitable purpose.

A “mobile device” may comprise any electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, etc. A mobile device may comprise any suitable hardware and software for performing such functions, and may also include multiple devices or components (e.g., when a device has remote access to a network by tethering to another device—i.e., using the other device as a relay—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

A “payment account credential” and “card credential” can be used synonymously.

An “authorization system” may refer to a system, a device, or components of a device that may utilize information to determine the probability or likelihood that a transaction is fraudulent. Although the term “merchant processor” may be referred to separately from an “authorization system,” in some embodiments they may comprise one and the same system or systems that may perform substantially the same functionality, but in relation to different components of the system (e.g. providing information to a merchant or an issuer). In some embodiments, authorization systems may quantify the probabilities or likelihood of a fraudulent transaction by generating a “risk score.” In some embodiments, the authorization system may approve or reject a transaction. An exemplary embodiment of an authorization system is provided in U.S. Pat. No. 7,809,650 to Bruesewitz et al. entitled “Method and System for Providing Risk Information in Connection with Transaction Processing,” which is hereby incorporated by reference in its entirety. It should be understood that embodiments are not so limited.

An “authorization request message” may be an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center-response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “communications channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instance comprise a “secure communication channel,” which may be established in any known manner, including the use of mutual authentication and a session key and establishment of a secure socket layer (SSL) session. However, any method of creating a secure channel may be used. By establishing a secure channel, sensitive information related to a payment device (such as account numbers, CVV values, expiration dates, etc.) may be securely transmitted between the two or more entities to facilitate a transaction.

A “verification token” may refer to a secured device or component of a device (such as a software or hardware module) that may be used to authenticate or validate a user or payment device. That is, for example, the verification token may refer to a secured component (or components) of a mobile device used to determine that a user is not misrepresenting his identity and/or that he has in his possession a payment device. An example of a verification token is provided in U.S. Pat. No. 7,891,560, issued Feb. 22, 2011, to Hammad, which is hereby incorporated by reference in its entirety. In general, a verification token may take any suitable form, including an embedded software/hardware module in a mobile device or an attachment to a mobile device (such as a universal serial bus (USB) stick or other periphery component). A verification token that is coupled to, or embedded within, a mobile device may be considered a component of the mobile device (even if the verification token could be physically separated from the mobile device). In some embodiments (e.g. where the verification token is an external component), a verification token that may be coupled to or embedded within a mobile.

“Randomly” can include pseudo-randomly. Pseudo-random generators are often implemented in hardware or software on computers and are accessible through modern programming languages. Pseudo-random selections can include algorithmic selections which appear on the surface to be random but are mathematically deterministic. For example, the function rand( ) is available in the C programming language through the stdlib.h library, and selections using the rand( ) function are considered randomly selected.

Steganography Techniques

Within unsecure networks, such as GSM cell phone networks, card credentials can be represented in a format that is different from text string-based card credentials in order to hide the credentials from identity thieves. In embodiments, card credentials can be represented in the form of hidden portions within an image/audio/video and further obfuscated using lossy compression. Values in filters used by the compression algorithm preferably match between each end.

In an embodiment, a card credential is created with a digital dynamic watermark embedded using a high quality image/audio encoder with quantization table and filter. A quantization table and filter constructed to embed conventional card data (PAN, expiration date, CVV, CVV2) within the image or audio can be used. A card credential can be embedded using a mobile device and represented using this format.

For example, a quantization filter for a JPEG is often represented as a two-dimensional matrix of values. These values are applied to an uncompressed image based on a discrete cosine transformation, effectively changing the image from a spatial domain into a frequency domain. In the frequency domain, values representing higher frequencies can be truncated, nominally because humans do not distinguish high frequency information as well as low frequency information. The truncation results in a “lossy” compression, meaning that some information about the original image is lost in during compression.

A typical JPEG quantization table is an eight by eight matrix of integers. Other sizes of tables can be used, and other compression algorithms can be used as are known in the art. During compression, each eight-by-eight block of each component of an image (Y, Cb, Cr) is converted to a frequency-domain representation, using a normalized, two-dimensional type-II discrete cosine transform. The discrete cosine transform is sometimes referred to as “type-II discrete cosine transform” in the context of a family of transforms as in discrete cosine transform, and the corresponding inverse discrete cosine transform is denoted as “type-III discrete cosine transform.”

The quantization table can be normalized around zero, so that the average of all of the values in the matrix are zero.

After normalization around zero, a two dimensional discrete cosine transformation can be applied using the equation:

G_{u,v}=SUMₓ(SUM_{y}(α(u)*α(v)*g_{x,y}*cos(pi/8*(x+½)*u)*cos(pi/8*(y+½)*v)))

where u includes 0 to 7, v includes 0 to 7, and α(u)={sqrt(⅛) if u=0; else sqrt(¼)}. The value g_{x,y} is the value of the pixel at x,y, and G_{u,v} is the discrete cosine transform coefficient at u,v, in the frequency domain.

After converting to the frequency domain, each value of the eight-by-eight G matrix is divided by a value in an eight-by-eight quantization matrix Q and then rounded to the nearest integer.

An example of an eight-by-eight quantization table Q is:

Quantization Table

| | | | | | | | |
|---|---|---|---|---|---|---|---|
| 16 | 11 | 10 | 16 | 24 | 40 | 51 | 61 |
| 12 | 12 | 14 | 19 | 26 | 58 | 60 | 55 |
| 14 | 13 | 16 | 24 | 40 | 57 | 69 | 56 |
| 14 | 17 | 22 | 29 | 51 | 87 | 80 | 62 |
| 18 | 22 | 37 | 56 | 68 | 109 | 103 | 77 |
| 24 | 35 | 55 | 64 | 81 | 104 | 113 | 92 |
| 49 | 64 | 78 | 87 | 103 | 121 | 120 | 101 |
| 72 | 92 | 95 | 98 | 112 | 100 | 103 | 99 |

For each value B_{j,k}=round (G_{j,k}/Q_{j,k}) for j=0 through 7 and k=0 through 7. The rounding creates the lossiness in the algorithm, with the benefit of further hiding the sensitive financial data in the steganographic image. It can be extremely difficult for one to decode the hidden information in a steganographic image if the compressed image is not uncompressed using the same quantization table that was used to compress it.

For audio files, which can essentially be value with respect to time, filter values are used. An uncompressed sound can be converted to a frequency domain using a one-dimensional discrete cosine transformation algorithm. A vector (e.g., 1×m matrix) of filter values can be used for compression. High frequency information can be truncated or otherwise discarded. In some ways, audio information is a one-dimensional problem and images (and video) are a two-dimensional problem.

There are other ways to embed information in images, sound, and video. For example, a tiny portion of a high resolution image can hold hidden information. Because the tiny portion (e.g., a swatch of a few pixels) is so small, a human may not recognize that it even exists, let alone recognize text, a bar code, or other code embedded therein.

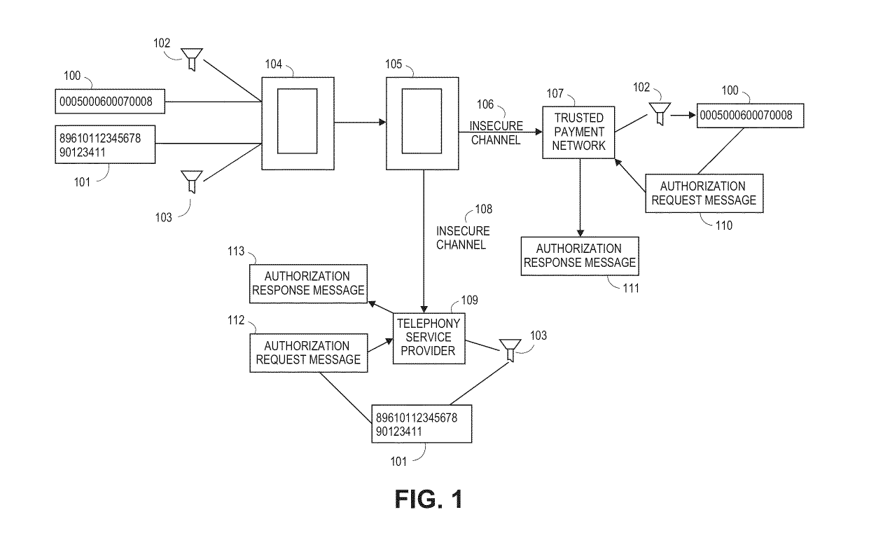

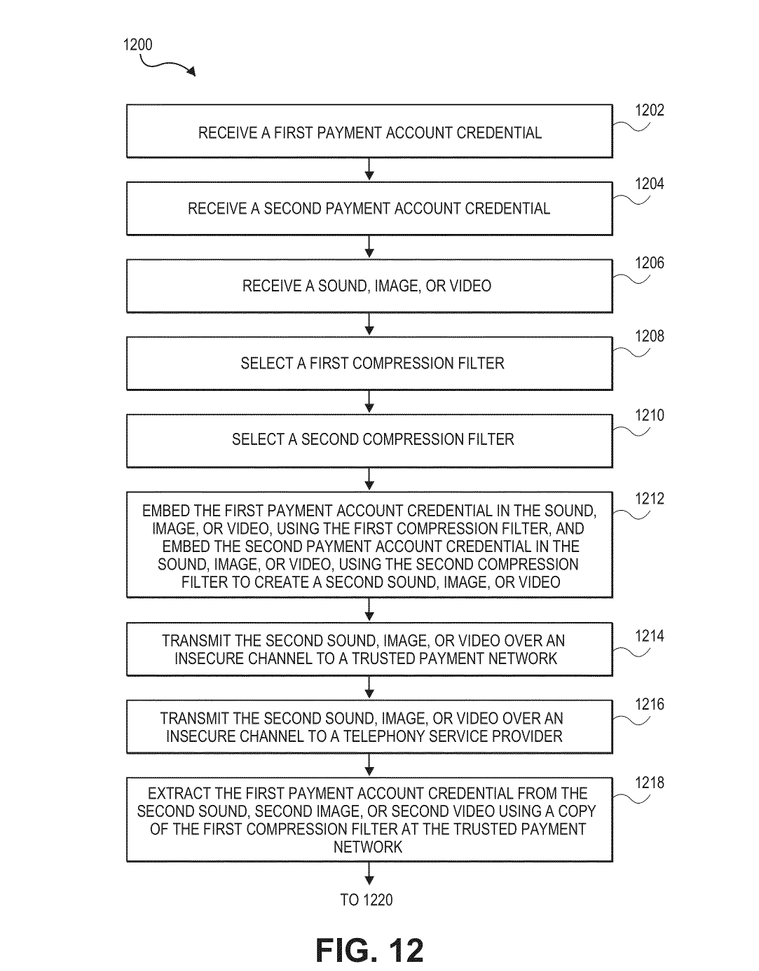

FIG. 1 illustrates embedding multiple payment credentials into an image using multiple compression filters, transmitting the image over an insecure channel, extracting credentials, authenticating, and initiating a transaction in accordance with an embodiment. Payment credentials 100 and 101 are embedded into image 104 using compression filters 102 and 103 respectively to create image 105. Image 105 is transmitted over insecure channel 106 to trusted payment network 107, image 105 is also transmitted over insecure channel 108 to telephony service provider 109. At trusted payment network 107, a copy of compression filter 102 is applied to image 105 to extract payment credential 100. Payment credential 100 is included in authorization request message 110, which is transmitted through trusted payment network 107 to initiate a transaction. Trusted payment network 107 then sends authorization response message 111 indicating status of the transaction authorization. At telephony service provider 109, a copy of filter 103 is applied to image 105 to extract payment credential 101. Payment credential 101 is included in authorization request message 112, which is transmitted through telephony service provider 109 to initiate a transaction. Telephony service provider 109 then sends authorization response message 113 indicating status of the transaction authorization. FIG. 11 is a flow chart depicting this process.

A telephone service provider can include a local, long distance, or wireless telecommunications carrier, such as AT&T, Verizon, etc., or as otherwise known in the art. A trusted payment network can include a branded or unbranded network for facilitating credit or debit payments from cards, financial accounts, or as otherwise known in the art. For example, VisaNet is an example of a trusted payment network. The insecure channels may be over public networks (e.g., the Internet), private networks, or virtual private networks. The insecure networks may be the same physical network or different physical networks. Small, point-to-point networks may also serve as insecure networks, such as a near field communication (NFC) connection between a wireless device and a terminal.

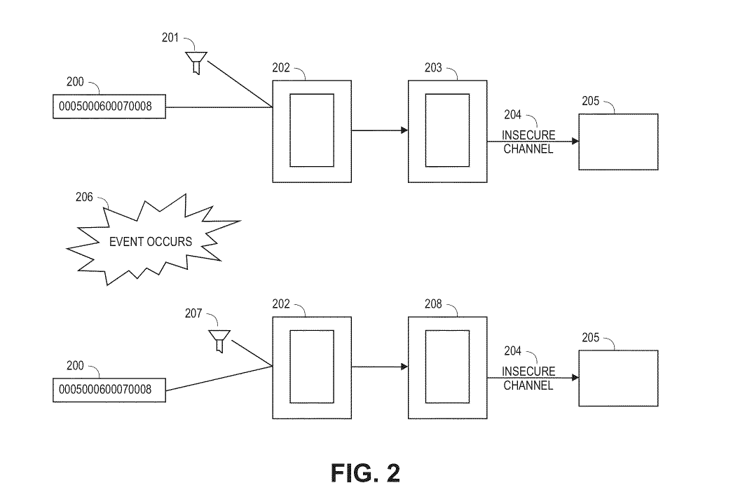

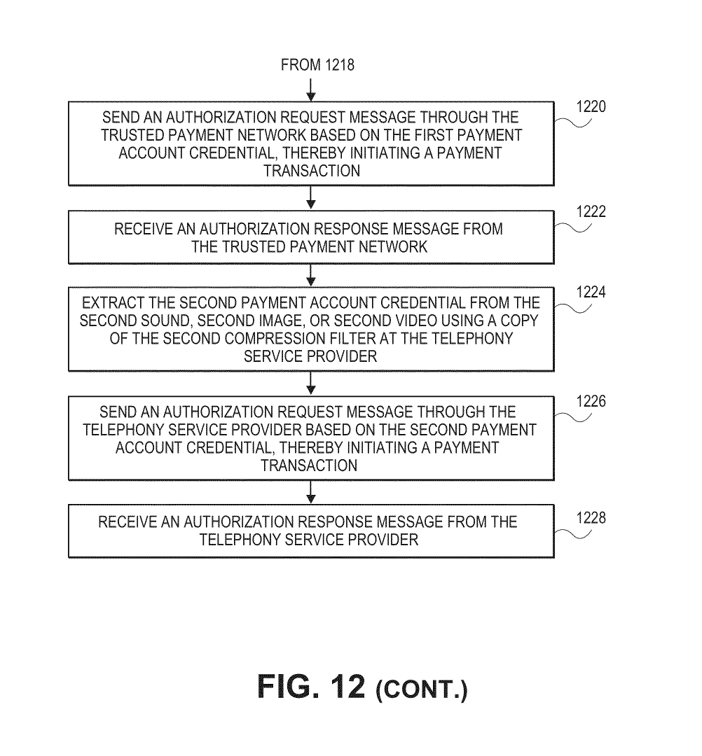

FIG. 2 illustrates updating a compression filter for embedding steganographic signatures upon an event occurring, and retransmitting an image embedded with a payment credential over an insecure channel in accordance with an embodiment. Initially, payment credential 200 is embedded into image 202 using compression filter 201 to create image 203. Image 203 is transmitted over insecure channel 204 to a destination 205. Upon determination that event 206 has occurred, steganographic signatures are to be updated. Payment credential 200 is embedded into image 202 using compression filter 207 to create image 208. Image 208 is transmitted over insecure channel 204 to a destination 205. FIG. 12 is a flow chart depicting this process.

Upon an event, and not necessarily with a periodic passage of time, a filter can be changed from one to another. For example, if the embedded image is changed, either in content or resolution, a new filter can be added. As another example, if a mobile device switches from a NFC to LTE (Long Term Evolution) channel, a new filter can be rotated into the mobile device for future payment communications. A user may roam to a different network or use a different phone in order to trigger that a new set of filter values be downloaded.

The entire filter can be changed, or sub-portions of the filter can be updated. For example, in some cases only a few of the 64 values in a JPEG quantization table may be changed, leaving the rest of the coefficients as is. Thus the backend server and phone use the same, synchronized filter values in order to encode and decode an audio, image, or video file.

To increase the security robustness, the backend server may dynamically rotate/change the quantization table and filters applied for the encoder/decoder. The user image/audio clip may be dynamically updated to work with the changed quantization table and filters. The user visible image (or audibly recognizable audio clip) may remain the same while changing only the embedded data.

The user image/audio clip may be dynamically updated to work with the changed quantized table and filters. The user visible image (or audibly recognizable audio clip) may remain the same while changing only the embedded data.

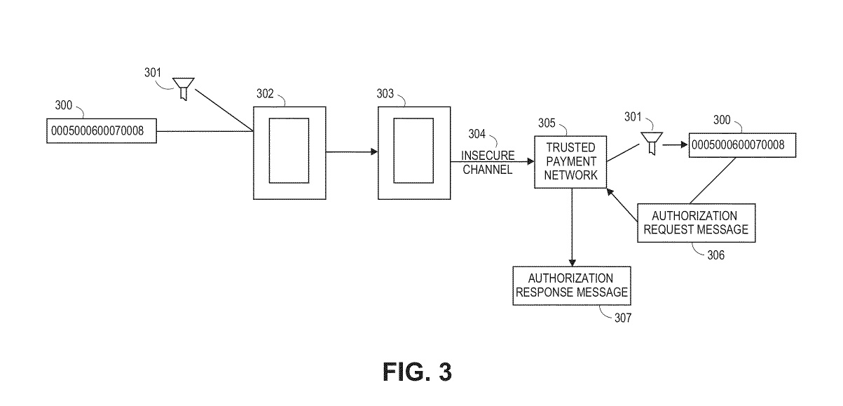

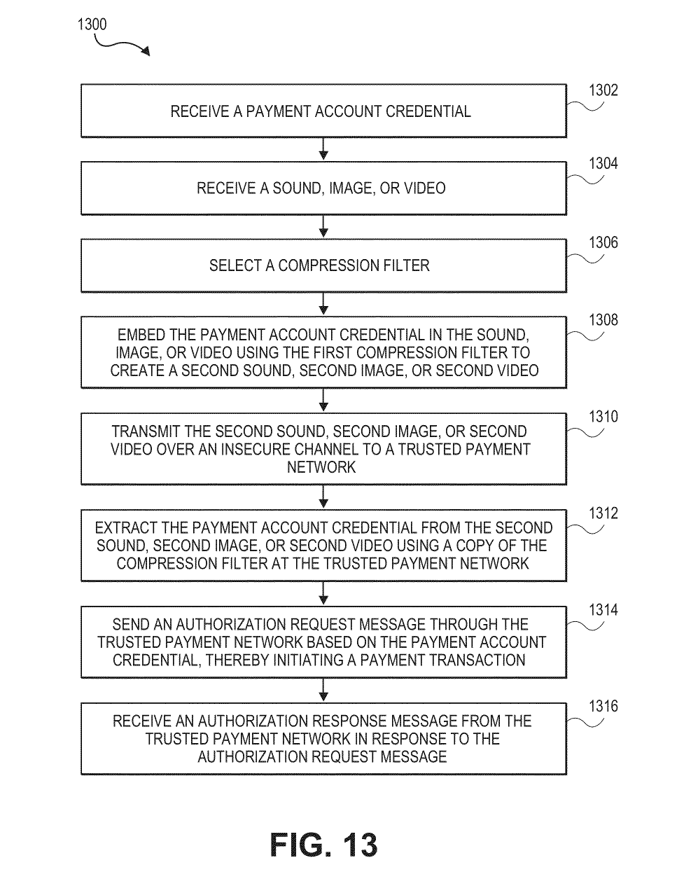

FIG. 3 illustrates embedding a payment credential into an image using a compression filter, transmitting the image over an insecure channel, extracting the credential, authenticating, and initiating a transaction in accordance with an embodiment. In the system, payment credential 300 is embedded into image 302 using compression filter 301 to create image 303. Image 303 is transmitted over insecure channel 304 to trusted payment network 305. At trusted payment network 305, a copy of compression filter 301 is applied to image 305 to extract payment credential 300, which then is included in authorization request message 306. Authorization request message 306 is transmitted through trusted payment network 305 to initiate a transaction, after which trusted payment network 305 sends authorization response message 307 indicating status of the transaction authorization. The FIG. 13 is a flow chart depicting this process.

Trusted payments networks such as Visa, MasterCard, Discover, AMEX, PayPal, and others can be used to process transactions, such as but not limited to eCommerce, within social networks, money transfer or personal payments, mobile commerce, proximity payments, gaming, and/or the like for retail purchases, digital goods purchases, utility payments, purchasing games or gaming credits from gaming websites, transferring funds between users, and/or the like. Status messages from a trusted payment network provide the status of a proposed transaction. As discussed previously, some status messages include transaction approval, transaction decline, call required. Status messages may also include an authorization code.

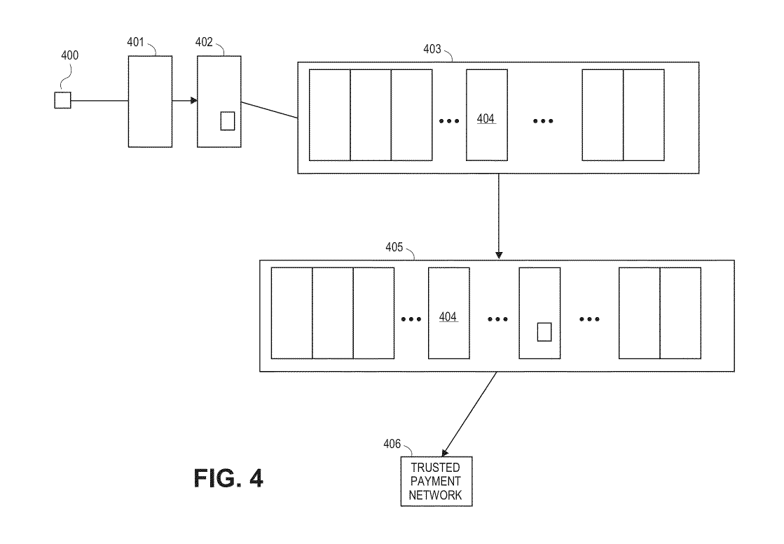

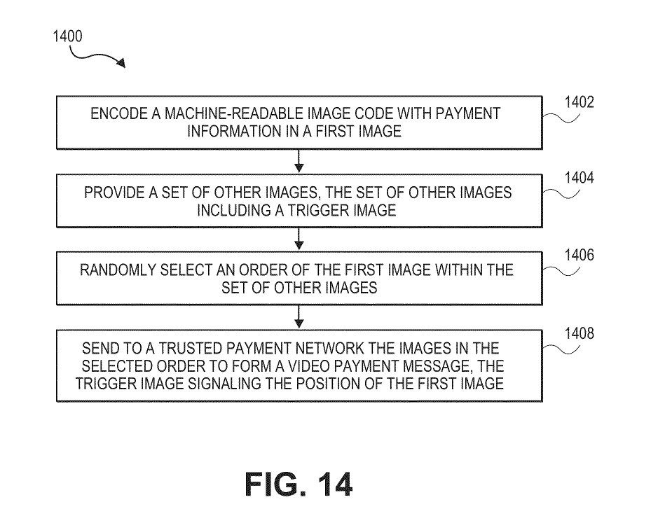

FIG. 4 illustrates sending payment information through a video, by inserting an image with payment information embedded, into a set of other images in a random location to form a video payment message, and sending that video to a trusted payment network in accordance with an embodiment. Image code 400 is embedded into image 401 to create image 402. Image 402 is inserted into a set of other images 403 at a random point to create video 405. The other images 403 contain a trigger image 404 in a random location, which indicates the location of image 402. Video 405 is sent to trusted payment network 406. FIG. 14 is a flow chart depicting this process. Examples of the trigger image indicating the location of image 402 include immediately preceding or succeeding image 402, or being a set number of images away from image 402, with the set number known by the trusted payment network.

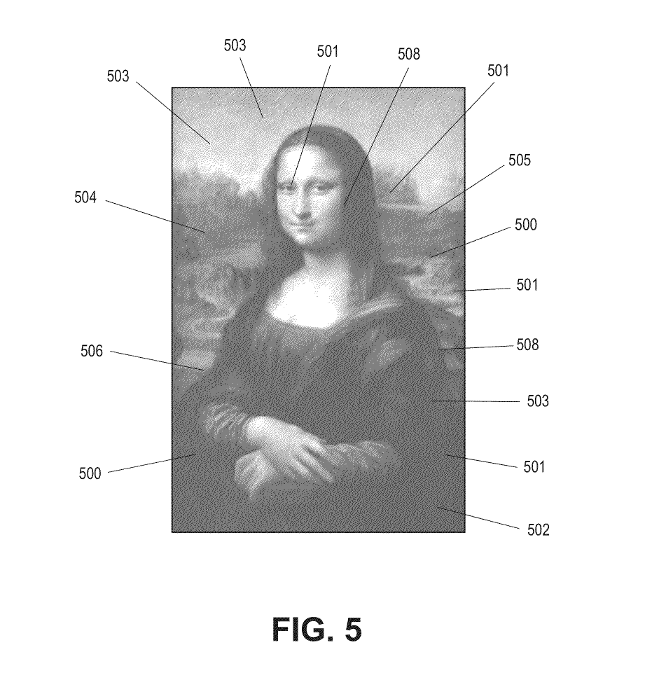

In FIG. 5, an image of the Mona Lisa has several areas within it in which information is embedded. Some data is spread over multiple locations (see reference identifiers 500, 501, 503, 507) and other data is put in only one location (see reference identifiers 502, 504, 505, 506). As described above, non-location-based embedding techniques can also be used. Further encoding using one or more least significant bits of each color with information can be employed. Then, the image can be compressed or otherwise transformed using a quantization table or other filter. Without the particular filter values, it is difficult, if not impossible, to extract the hidden data from the image.

Data can be spread over multiple locations by separating breaking the data to be embedded into a known number of pieces of a known sizes and placing those pieces into multiple locations within a file. When extracting the embedded data at a later time, these pieces from multiple locations are reassembled to recreate the original embedded data.

Embedding data in the least significant bits of a target media file may be used to embed data into a variety of digital media files, by manipulating the least significant bits of a certain bytes of a target digital media file. The technique can work by taking the bits of data to be embedded, and for example, sequentially or randomly replacing the least significant bits of a target digital media file in a manner known to a party that will later be extracting the embedded data.

A unique watermark can generally only be extracted from a party who has a filter/quantization table. In one implementation, the trusted backend server (e.g., Visa) may be the only entity that has access to the filter/quantization table. Computers and people without enough knowledge would typically not be able to detect and extract the correct information from a noise injected image, audio, or video without the appropriate quantization table and filter.

Using the above techniques, card credentials, such as an account number, expiration date, CVV, etc. can be embedded into an audio, image, or video file. If a proper filter and quantization table is applied from the server, the correct card credentials can be exposed.

Technical advantages are many. Representing account numbers in an image/audio/video format allows the user to associate an image/audio file with an account number while reducing the exposure of account information. For example, a user cannot verbally or in written form easily expose his or her account number. This can be applied to situations in which there is an insecure network, such as a GSM cell phone network. Therefore, account credentials can be sent over insecure GSM cell phone networks that are prevalent in developing countries.

Embedding an account number in the image/audio/video allows for using more information to generate an account number than the traditional 16 numeric digits. Using more information for the account number makes it difficult for an attacker to fabricate valid account Information.

Besides being used for account numbers and other financial information, this can be used to verify that a recipient or sender of information is authentic, that a channel is secure, or other non-financial related verifications. For example, an institution may be an individual on his or her cell phone. The individual may send audio with an embedded password within the audio stream to indicate that the individual is authentic. This may be how an issuer bank, calling one of its customers because of suspected fraud on the customer's account, may be able to authenticate the customer. This can also be used between two individuals who might not necessarily recognize each other's voice. It may also be used to authenticate MMS (Multimedia Messaging Service) messages having sounds or images attached therein.

In some embodiments, a trusted backend server (e.g., Visa) provides a user device with a steganographic image that includes the user's account number.

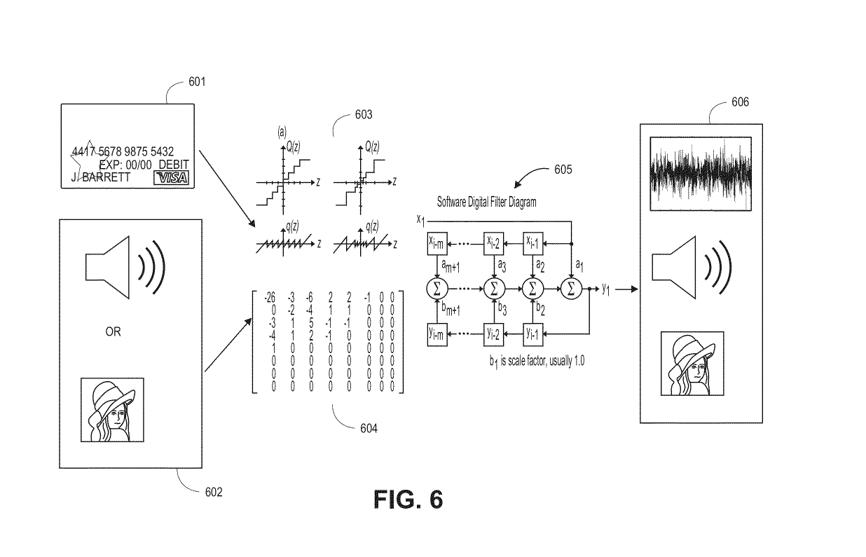

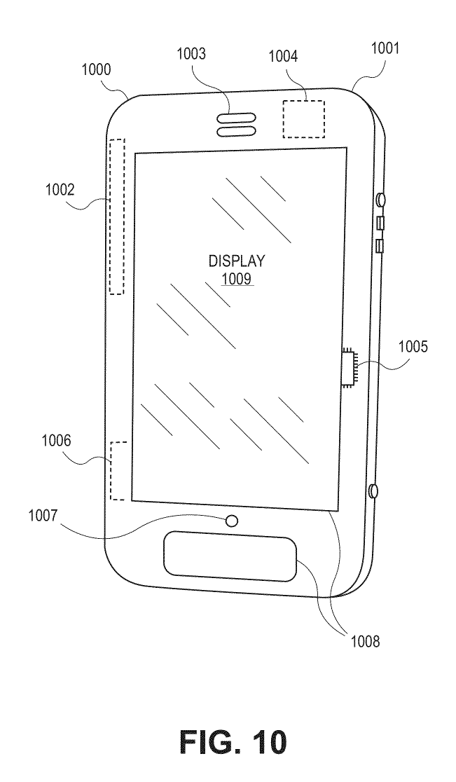

In FIGS. 6 and 9A, a steganographic image is coded using a quantization table and filter only known to the trusted backend server. Credit card, debit card, or other payment card information is embedded with a two-dimensional quantization table from the server, such as a quantization table using the JPEG codec standard described above.

To make a payment, a user may take a picture of his or her face with a mobile device, and the mobile device can embed account information within the picture before compressing using a quantization table, as shown. In another example, a user may speak into a microphone of his or her mobile device, and the mobile device can embed account information within the audio before compressing using a filter.

In FIG. 6, information from payment card 601 is embedded in image or sound 602 using quantization filter 603, which includes quantization table 604. Software filter diagram 605 is illustrative of a process used by the filter to embed card information into an image or sound, to produce embedded sound or image 606.

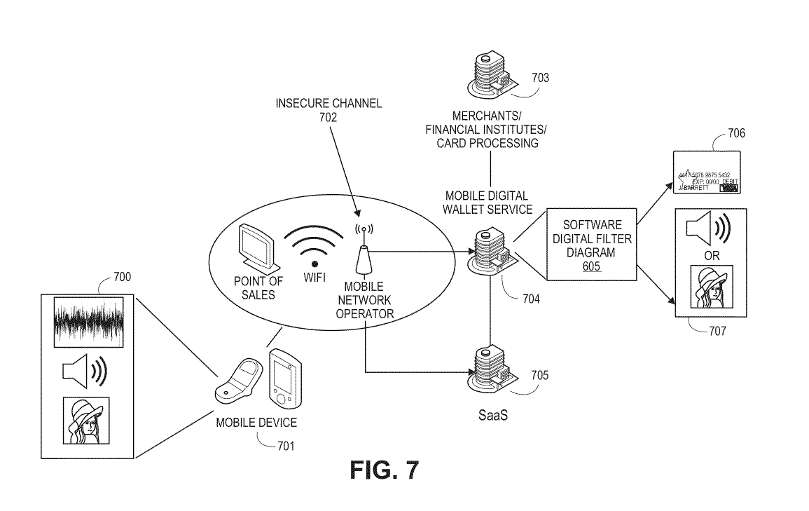

In FIGS. 7 through 9B, a POS (point of sale) terminal provides a conduit for a user device to send a steganographic image, created from a ‘clean’ image and data, to a merchant through an insecure communication channel (e.g., Bluetooth, USSD, NFC). The mobile device embeds account information within audio or a picture and compresses the audio or picture using a lossy compression algorithm, such as a JPEG compression. The merchant's POS terminal may also be enabled to embed financial details within the image. For example, the phone may embed a user's account number and expiration date, and the POS terminal may embed an amount of the transaction and currency code in the same image.

The merchant sends the steganographic image to the trusted backend server for verification. The trusted backend server can encode/decode the embedded sound or image, to separate into payment credentials and the ‘clean’ image, as illustrated in FIG. 9B. The decoded image can be compared with a copy of the ‘clean’ image to ensure that the decoding did not have substantial errors. Payment credentials can be sent to a processing database for authorization. An authorization request and response can be generated through a traditional card authorization network, such as VisaNet.

In FIG. 7, an embedded sound or image 700 is sent by a mobile device 701 to a point of sale terminal. The point of sale terminal sends the embedded sound or image through an insecure communication channel 702 to a trusted backend server. The trusted backend server has mobile digital wallet service 704, card processing server 703, and SaaS server 705. On the trusted backend server, payment credentials 706 and sound or image 707 are extracted from embedded sound or image 700 by applying the filter of 605.

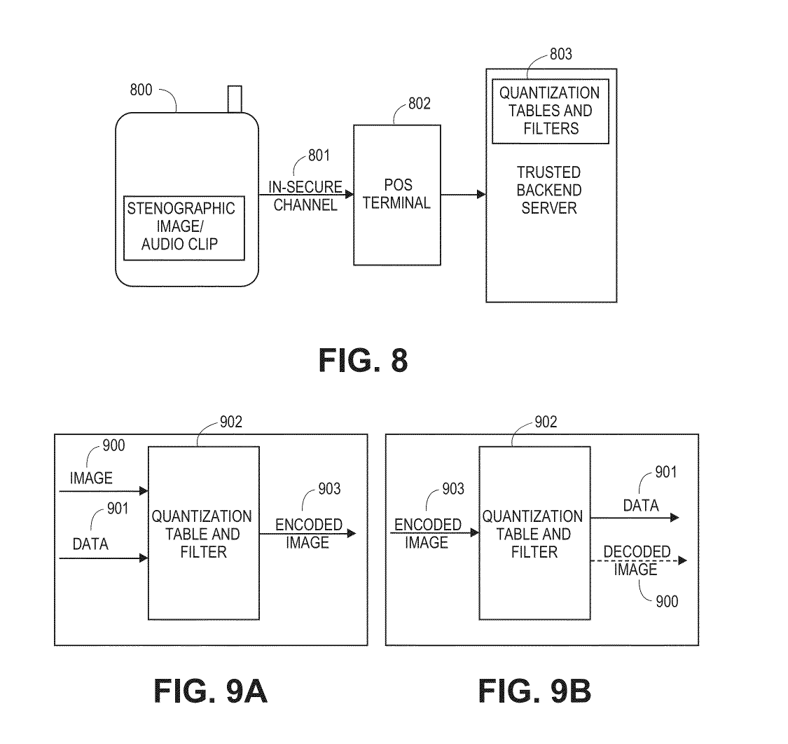

In FIG. 8, an embedded audio clip or image is sent by a mobile device 800, through an insecure communication channel 801 to a point of sale terminal 802. The point of sale terminal then sends the embedded audio clip or image to trusted backend server 803, which contains quantization tables and filters.

In FIG. 9A, image 900 and data 901 have quantization table and filter 902 applied to them to produce encoded image 903.

In FIG. 9B, the reverse process is depicted, where encoded image 903 has quantization table and filter 902 applied to it to produce data 901 and image 900.

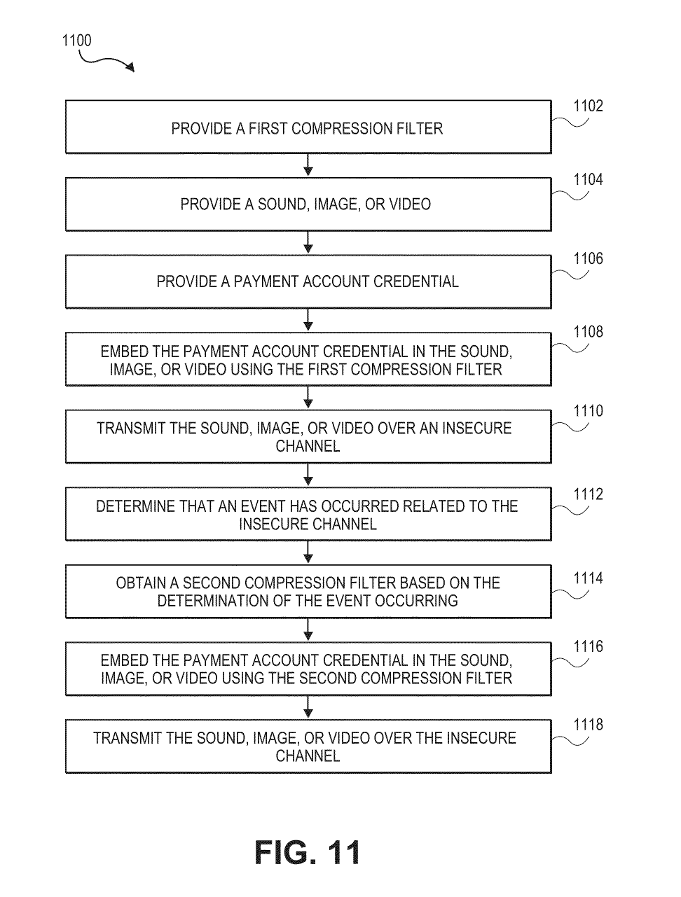

FIG. 10, is a diagram of an exemplary mobile device 1000 is that may be used in some embodiments. In some embodiments, the mobile device 1000 may be a notification device that can receive alert messages, a payment device that can be used to make payments, an access device (e.g., POS device) that may receive information from a consumer to conduct a transaction, and/or a multi-purpose general use device. The exemplary mobile device 1000 may comprise a tangible, non-transitory computer readable medium 1006 that be present within the body (or outer casing) 1001, or the computer readable medium 1006 could be detachable from the device (e.g., the computer readable medium 1006 could comprise an external memory that could be connected through a physical interface such as a USB connection, or the data could be hosted remotely and accessed wirelessly by the device—e.g. the data could be hosted and stored at a remoter server in the “cloud”). The computer readable medium 1006 may be in the form of a memory that stores data. The memory may store information such as financial information, transit information (e.g., as in a subway or train pass), access information (e.g., access badges), serial numbers, mobile account information, and any other suitable information. In general, any of this information may be transmitted by the mobile device 1000, via any suitable method, including the use of antenna 1002 or contactless element 1004. The body 1001 may be in the form a plastic substrate, housing, or other structure.

In some embodiments, the mobile device 1000 may further include a contactless element 1004, which is typically implemented in the form of a semiconductor chip (or other data storage element) with an associated wireless transfer (e.g., data transmission) element, such as an antenna. Contactless element 1004 may be coupled to (e.g., embedded within) the mobile device 1000 and data or control instructions that are transmitted via a cellular network may be applied to the contactless element 1004 by means of a contactless element interface. The contactless element interface functions to permit the exchange of data and/or control instructions between the mobile device circuitry and an optional contactless element 1004, or between another device having a contactless element (e.g., a POS terminal or a payment device). Contactless element 1004 may be capable of transferring and receiving data using a short range wireless communication capability. As noted above, mobile device 1000 may comprise components to both be the interrogator device (e.g., receiving data) and the interrogated device (e.g., sending data). Thus, the mobile device 1000 may be capable of communicating and transferring data or control instructions via both cellular network (or any other suitable wireless network—e.g. the Internet or other data network) and short range communications.

The mobile device 1000 may also include a processor 1005 (e.g., a microprocessor) for processing the functions of the mobile device 1000 and a display 1009 to allow a consumer to see phone numbers and other information and messages. The mobile device 1000 may further include input elements 1008 to allow a user to input information into the device, a speaker 1003 to allow the user to hear voice communication, music, etc., and a microphone 1007 to allow the user to transmit her voice through the mobile device 1000. The mobile device 1000 may also include an antenna 1002 for wireless data transfer (e.g., data transmission).

In an embodiment, a person can speak his or her name to create audio in which a financial account information is embedded. For example, a person can speak “My name is Joe and I authorize this transaction” into a cell phone microphone. The user can be located away from a merchant, bank, or Internet infrastructure, such as in a small village of a developing country. All that may be available is an unsecure GSM wireless telephone network. After the user speaks, his or her financial information, such as a primary account number (PAN) may be embedded within the audio stream.

The embedded PAN as well as the voice sample can be used as an authentication tool. For example, a human can recognize the voice as the user, and a computer can decode and extract the PAN to verify the authenticity of the user. Using both a human and a computer to verify the authenticity of a remote person can be efficient.

Besides financial information, other information, such as a key word or password, can be embedded in order to establish that the speaker is authentic. For example, if two people are communicating over cell phones, a password may be inserted by one phone using steganographic techniques, and the second phone may find, extract, and confirm the password. The second phone may then indicate that the speaker is authentic to its user. The second phone can insert a separate password over the same network, and the first phone can insert it using steganographic techniques. The first phone then can find, extract, and confirm the second password.

In the prior art, images and sound quantization tables and filters are typically calibrated to provide acceptable quality of service at the end user. In embodiments, the quantization tables and filters are adjusted, without entirely corrupting the resulting images, in order to further hide the steganographically hidden data within. Without the proper quantization tables and filters the audio stream or image cannot be properly recovered efficiently.

In embodiments, the quantization tables and filters are kept protected at the trusted backend server (e.g., a Visa server) and used for hiding and recovering information embedded in the audio or image. The quantization tables and filters can be dynamically changed at the trusted backend server, such as in a cloud-based electronic wallet, and then pushed out to update the various cards, mobile devices, and other portable consumer devices. The data can also be pushed out to POS terminals.

For example, at a POS terminal, the image/audio file with the embedded account number may be passed to the POS terminal and verified by the trusted backend server.

In one use case, card credentials are represented using an image format stored on a user's mobile device. The card credentials may be in the form of a tiny QR code hidden in an image, and the image is compressed using a JPEG codec and eight-by-eight quantization table. The image is presented to a payment terminal for checkout, transferring its electronic image through a Bluetooth connection to the payment terminal. The payment terminal sends the image with the embedded card credentials to a background server. The server uses the same quantization table for decompression and extracts the hidden card credentials from the JPEG image.

In another embodiment, card credentials are represented using an audio format stored on a mobile device. Audio is injected with a user's voice when connected through an interactive voice response (IVR) system for checkout or authentication. For example, a user wishing to transfer money to a friend, may speak into a cell phone's microphone his or her name. An account number, expiration date, and CVV code are embedded in the audio stream, which is compressed by an audio codec using a filter with predetermined values. The steganographic hiding and compression can occur using an application in the phone's SIM card. Some SIM cards have processors that can compress data and hide account information in real time. The audio is sent to a central server, and the audio is then decompressed using the same filter values as were used for compression of the audio. The account number, expiration date, and CW are extracted using the algorithm used for the steganographic emplacement.

In another embodiment, card credentials based on lossy compression are transmitted via an NFC channel in the clear where a payment gateway or wallet provider can only extract out a watermark using a quantized table and filter. The NFC channel may cover a large area of a store, which could be intercepted by a thief with the right equipment. The watermark goes unnoticed by the thief because it is a subtle change in the data. The watermark can also ensure store patrons that the wireless network is authorized by the store.

In another embodiment, card credentials based on lossy compression (audio) are transmitted via a USSD channel in the clear where a payment gateway or wallet provider can only extract out a watermark using quantized table and filter. The underlying data is both hidden because it is subtle, and it is subject to compression using values that are kept secret.

FIG. 11 is a flowchart of a process 1100 in accordance with an embodiment. In operation 1102, a first compression filter is provided. In operation 1104, a sound, image, or video is provided. In operation 1106, a payment account credential is provided. In operation 1108, the payment account credential is embedded in the sound, image or video using the first compression filter. In operation 1110, the sound, image, or video is transmitted over an insecure channel. In operation 1112, an event is determined to have occurred related to the insecure channel. In operation 1114, a second compression filter is obtained based on the determination of the event occurring. In operation 1116, the payment account credential is embedded in the sound, image, or video using the second compression filter. In operation 1118, the sound, image, or video with the embedded payment account credential is transmitted over the insecure channel.

FIG. 12 is a flowchart of a process 1200 in accordance with an embodiment. In operation 1202, a first payment account credential is received. In operation 1204, a second payment account credential is received. In operation 1206, sound, image, or video is received. In operation 1208, a first compression filter is selected. In operation 1210, a second compression filter is selected. In operation 1212, the first payment account credential is embedded in the sound, image, or video, using the first compression filter, and the second payment account credential is embedded in the sound, image, or video, using the second compression filter to create a second sound, image, or video. In operation 1214, the second sound, image, or video is transmitted over an insecure channel to a trusted payment network. In operation 1216, the second sound, image, or video is transmitted over an insecure channel to a telephony service provider. In operation 1218, the first payment account credential is extracted from the second sound, second image, or second video using a copy of the first compression filter at the trusted payment network. In operation 1220, an authorization request message is sent through the trusted payment network based on the first payment account credential, thereby initiating a payment transaction. In operation 1222, an authorization response message is received from the trusted payment network. In operation 1224, the second payment account credential is extracted from the second sound, second image, or second video using a copy of the second compression filter at the telephony service provider. In operation 1226, an authorization request message is sent through the telephony service provider based on the second payment account credential, thereby initiating a payment transaction. In operation 1228, an authorization response message is received from the telephony service provider.

FIG. 13 is a flowchart of a process 1300 in accordance with an embodiment. In operation 1302, a payment account credential is received. In operation 1304, a sound, image, or video is received. In operation 1306, a compression filter is received. In operation 1308, the payment account credential is embedded in the sound, image, or video, using the first compression filter to create a second sound, image, or video. In operation 1310, the second sound, image, or video is transmitted over an insecure channel to a trusted payment network. In operation 1312, the payment account credential is extracted from the second sound, second image, or second video using a copy of the compression filter at the trusted payment network. In operation 1314, an authorization request message is sent through the trusted payment network based on the payment account credential, thereby initiating a payment transaction. In operation 1316, an authorization response message is received from the trusted payment network in response to the authorization request message. A transaction may be approved or denied based upon the received authorization response message.

FIG. 14 is a flowchart of a process 1400 in accordance with an embodiment. In operation 1402, a machine-readable image code is encoded with payment information in a first image. In operation 1404, a set of other images, including a trigger image is provided. In operation 1406, an order of the first image within the set of other images is randomly selected. In operation 1408, the images in the selected order are sent to a trusted payment network to form a video payment message, with the trigger image signaling the position of the first image.

Paying Via Video Meme

In some embodiments, a video platform captures payment detail in randomized tokens. The order and meaning of these tokens is known only by a back end server. The video is optionally compressed and transmitted to the server, where the parts are identified and reassembled into an authorization for payment using an authorization payment sequence as described below. The system then transmits the payment verification to the payee and then settles with the appropriate financial institutions, as described below.

Video, instead of or in addition to images and audio, may be a very secure method of initiating a payment. A six second clip can alternate many payment “tokens” (bar code, QR code, randomized patterns, etc.). Each of these alternates can be a dummy or contain partial snippets of payment message information. The bar code, QR code, etc. can be steganographically embedded within one or more image frames of the video.

The ordering and patterns can be selected randomly using pseudo-random generators. Pseudo-random generators are available in many computers and accessible through various programming languages.

The image frame(s) with steganographic information can be distinguished by a light or image that indicates which piece of the message will appear next. For example, after a light flashes twice the BIN (bank identification number) will be displayed via a QR code. Then after three flashes the remaining PAN digits may be displayed. Then, a blue flash indicates the CW while a yellow flash may indicate a false CW.

The combination of real and fake information is virtually limitless, and a fraudster would have no idea how to reconcile the correct order or indicia of each message part because they could change for each transaction and be reassembled via a remote server.

Such video messages could be sent through an online social networking/media platform, including those catering to short videos, such as Facebook's Instagram platform or Twitter's Vine platform. A video payment message can be sent to the social media platform with the intended recipient of the payment and a trusted payment network, such as Visa, as parties tagged to the video. “Tagging” a person in a social network includes identifying or otherwise referencing a user of the social network or another individual who is not associated with the network.

In an alternate embodiment, the trusted payment network can be the party tagged to the video and the recipient's account information is encoded within the video payment message.

In another alternate embodiment, the intended recipient is the party tagged to the video, and the intended recipient forwards or submits the payment video to a trusted payment network. The intended recipient can submit the video or parse/decode the video for payment information, etc. and submit an authorization request message to the payment network. Other portions of the video may contain information regarding the product or service to be purchased, and that information may be sent in conjunction with the authorization request message.

Merchant or point of sale (POS) terminal information can be included in the video payment message, and the message can be decoded in order to build an authorization request message. The authorization request message can be sent through the trusted payment network.

The trusted payment network may determine that a video was used for the original payment message and therefore conduct additional fraud or authentication screening on the authorization message than would otherwise be used. Alternatively, less screening may be warranted because of the sophistication of the encoding, video, etc.

The payment network can forward the authorization request message to an issuer, or other like entity, and that entity can respond with an authorization response message allowing or denying the transaction. The payment network can forward the authorization response message back to the source, whether it be a merchant, point of sale terminal, or user. The transaction can then proceed.

It is understood that the various embodiments described are by way of example only, and are not intended to limit the scope of the invention. For example, many of the materials and structures described may be substituted with other materials and structures without deviating from the spirit of the invention. The present invention as claimed may therefore include variations from the particular examples and preferred embodiments described, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

All publications mentioned are incorporated by reference to disclose and describe the methods and/or materials in connection with which the publications are cited. The publications discussed are provided solely for their disclosure prior to the filing date of the present application. Nothing is to be construed as an admission that the present invention is not entitled to antedate such publication by virtue of prior invention. Further, the dates of publication provided may be different from the actual publication dates, which may need to be independently confirmed.

What is claimed is:

1. A method comprising:
providing a first compression filter;
providing a sound, image, or video;
providing a payment account credential;
embedding, using at least one processor operatively coupled with a memory, the payment account credential in the sound, image, or video using the first compression filter;
transmitting the sound, image, or video over an insecure channel;
determining that an event has occurred related to the insecure channel;
obtaining a second compression filter based on the determination of the event occurring;
embedding the payment account credential in the sound, image, or video using the second compression filter; and
transmitting the sound, image, or video over the insecure channel.

2. The method of claim 1 wherein the first and second compression filters include a quantization table.

3. The method of claim 2 wherein the quantization table is rotated prior to using the first and second compression filters.

4. The method of claim 2 wherein the quantization table is compatible with a standard of a Join Photographic Experts Group (JPEG) or Moving Picture Experts Group (MPEG).

5. The method of claim 1 wherein the embedding uses a lossy codec.

6. The method of claim 1 wherein the embedding is not specific to a location on the sound, image, or video.

7. The method of claim 1 wherein the first payment account credential is selected from the group consisting of an account number, an expiration date, and a card verification value.

8. The method of claim 1 wherein the second payment account credential includes a subscriber identity module (SIM) card number.

9. The method of claim 1 wherein the sound, image, or video is received from a trusted payment network.

10. A computer system executing instructions in a computer program, the computer program instructions comprising:
program code for providing a first compression filter;
program code for providing a sound, image, or video;
program code for providing a payment account credential;
program code for embedding the payment account credential in the sound, image, or video using the first compression filter;
program code for transmitting the sound, image, or video over an insecure channel;
program code for determining that an event has occurred related to the insecure channel;
program code for obtaining a second compression filter based on the determination of the event occurring;
program code for embedding the payment account credential in the sound, image, or video using the second compression filter; and
program code for transmitting the sound, image, or video over the insecure channel.

11. A method comprising:
receiving a first payment account credential;
receiving a second payment account credential;
receiving a sound, image, or video;
selecting a first compression filter;
selecting a second compression filter;
embedding, using at least one processor operatively coupled with a memory, the first payment account credential in the sound, image, or video, using the first compression filter, and embedding the second payment account credential in the sound, image, or video, using the second compression filter to create a second sound, second image, or second video;
transmitting the second sound, second image, or second video over an insecure channel to a trusted payment network;
transmitting the second sound, second image, or second video over an insecure channel to a telephony service provider;
extracting the first payment account credential from the second sound, second image, or second video using a copy of the first compression filter at the trusted payment network;
sending an authorization request message through the trusted payment network based on the first payment account credential, thereby initiating a payment transaction;
receiving an authorization response message from the trusted payment network;
extracting the second payment account credential from the second sound, second image, or second video using a copy of the second compression filter at the telephony service provider;
sending an authorization request message through the telephony service provider based on the second payment account credential, thereby initiating a payment transaction; and
receiving an authorization response message from the telephony service provider in response to the authorization request message.

12. The method of claim 11 wherein the compression filter includes a quantization table.

13. The method of claim 12 wherein the quantization table is rotated prior to using the compression filter.

14. The method of claim 12 wherein the quantization table is compatible with a standard of a Join Photographic Experts Group (JPEG) or Moving Picture Experts Group (MPEG).

15. A computer system executing instructions in a computer program, the computer program instructions comprising:
program code for receiving a first payment account credential;
program code for receiving a second payment account credential;
program code for receiving a sound, image, or video;
program code for selecting a first compression filter;
program code for selecting a second compression filter;
program code for embedding the first payment account credential in the sound, image, or video, using the first compression filter, and embedding the second payment account credential in the sound, image, or video, using the second compression filter to create a second sound, second image, or second video;
program code for transmitting the second sound, second image, or second video over an insecure channel to a trusted payment network;
program code for transmitting the second sound, second image, or second video over an insecure channel to a telephony service provider;
program code for extracting the first payment account credential from the second sound, second image, or second video using a copy of the first compression filter at the trusted payment network;
program code for sending an authorization request message through the trusted payment network based on the first payment account credential, thereby initiating a payment transaction;
program code for receiving an authorization response message from the trusted payment network;
program code for extracting the second payment account credential from the second sound, second image, or second video using a copy of the second compression filter at the telephony service provider;
program code for sending an authorization request message through the telephony service provider based on the second payment account credential, thereby initiating a payment transaction; and
program code for receiving an authorization response message from the telephony service provider in response to the authorization request message.

16. A method comprising:
receiving a payment account credential;
receiving a sound, image, or video;
selecting a compression filter;
embedding, using at least one processor operatively coupled with a memory, the payment account credential in the sound, image, or video, using the compression filter create a second sound, second image, or second video;
transmitting the second sound, second image, or second video over an insecure channel to a trusted payment network;
extracting the payment account credential from the second sound, second image, or second video using a copy of the compression filter at the trusted payment network;
sending an authorization request message through the trusted payment network based on the payment account credential, thereby initiating a payment transaction;
receiving an authorization response message from the trusted payment network in response to the authorization request message.

17. A method of sending payment information through a video, the method comprising:
encoding, using at least one processor operatively coupled with a memory, a machine-readable image code with payment information in a first image;
providing a set of other images, the set of other images including a trigger image;
randomly selecting an order of the first image within the set of other images;
sending to a trusted payment network the images in the selected order to form a video payment message, the trigger image signaling the position of the first image.

18. The method of claim 17 further comprising:
sending the video payment message to a social networking platform; and
tagging, on the social networking platform, an intended recipient of the payment information to the video payment message.

19. The method of claim 18 further comprising:
tagging, on the social networking platform a trusted payment network to the video payment message.

20. The method of claim 17 wherein the payment information encoded in the image code is for a recipient's account, the method further comprising:
sending the video payment message to a social networking platform; and
tagging, on the social networking platform, a trusted payment network to the video payment message.

21. The method of claim 17 further comprising:
sending the video payment message to a social networking platform;
tagging, on the social networking platform, an intended recipient of the payment information to the video payment message; and
forwarding or submitting by the intended recipient, the video payment message to a trusted payment network.

22. The method of claim 17 further comprising:
sending an authorization request message through the trusted payment network based on the payment information in the video payment message, thereby initiating a payment transaction; and
receiving an authorization response message from the trusted payment network.
